(19) United States
(12) Patent Application Publication
(10) Pub. No.: US 2019/0219419 A1
(43) Pub. Date: Jul. 18, 2019

(54) VEHICLE

(71) Applicant: Toyota Jidosha Kabushiki Kaisha, Toyota-shi Aichi-ken (JP)

(72) Inventors: Megumi Amano, Toyota-shi Aichi-ken (JP); Kohei Maejima, Nagakute-shi Aichi-ken (JP); Chika Kajikawa, Toyota-shi Aichi-ken (JP); Hikaru Gotoh, Nagoya-shi Aichi-ken (JP); Yoshiaki Matsumura, Toyota-shi Aichi-ken (JP); Chiharu Hayashi, Nagoya-shi Aichi-ken (JP)

(21) Appl. No.: 16/241,200

(22) Filed: Jan. 7, 2019

(30) Foreign Application Priority Data
Jan. 12, 2018 (JP) 2018-003208

(51) Int. Cl. G01C 21/36; H04W 4/021; H04W 4/024

(52) U.S. Cl. CPC G01C 21/3682; G01C 21/3617; H04W 4/024; H04W 4/021

(57) ABSTRACT

A vehicle is provided that includes a location acquiring unit that acquires a location of a vehicle, a counting unit that counts the number of visits to a location acquired by the location acquiring unit, and an information providing unit that, in a case that the number of visits counted by the counting unit exceeds a predetermined number, recommends a user of a vehicle to visit the location or provides a user of a vehicle with information about the location.

### CROSS-REFERENCE TO RELATED APPLICATION

This application is based on and claims priority under 35 USC 119 from Japanese Patent Application No. 2018-003208 filed on Jan. 12, 2018, the disclosure of which is incorporated by reference herein.

### BACKGROUND

### Technical Field

The present disclosure relates to a vehicle.

### Related Art

Japanese Patent Application Laid-Open (JP-A) No. 2009-092567 discloses a vehicle guidance system that provides a user of a vehicle with information about popular facilities. The vehicle guidance system described in JP-A No. 2009-092567 is configured including a car navigation device and an information center. When a facility is set to the car navigation device as a destination, the car navigation device uploads user information associating an intrinsic name of the facility, a genre name of the facility, and an area name in a license plate of the vehicle with one another, to the information center. The car navigation device also requests the information center to download facility information including degrees of popularity in a local area. The information center classifies uploaded and stored user information, associating intrinsic names of facilities with degrees of popularity in a local area of the facilities in the genre. When receiving a downloading request, the information center downloads facility information including intrinsic names of facilities and degrees of popularity in a local area of the facilities in a specified genre. This configuration enables the facility information to be provided for a user of the vehicle via the car navigation device.

Meanwhile, in a vehicle that an unspecified number of persons use as in the case of car sharing, the vehicle may also provide a user of the vehicle with a new attraction.

### SUMMARY

In consideration of the above facts, an object of the disclosure is to, in a vehicle that an unspecified number of persons use, provide a user of the vehicle with a new attraction.

A vehicle according a first aspect of the disclosure a location acquiring unit that acquires a location of a vehicle; a counting unit that counts a number of visits to a location acquired by the location acquiring unit; and an information providing unit that, in a case that the number of visits counted by the counting unit exceeds a predetermined number, recommends a user of the vehicle to visit the location or provides the user of the vehicle with information about the location.

According to the vehicle according to the first aspect of the disclosure, the number of visits to a location (place) acquired by the location acquiring unit is counted by the counting unit. For example, in the case of a vehicle that an unspecified number of persons use as in the case of car sharing, various persons (users) visit various places and the numbers of visits to the places are counted by the counting unit. In a case that the number of visits counted by the counting unit exceeds a predetermined number, the information providing unit recommends a user of the vehicle to visit a place where the counted number of visits thereto exceeds the predetermined number or provides the user of the vehicle with information about the place. As described above, a vehicle according to claim 1 is able to recommend a place where frequency of visits thereto by an unspecified number of persons is high, to a user of the vehicle, or is able to provide the user of the vehicle with information about a place where frequency of visits thereto by an unspecified number of persons is high.

A vehicle according to a second aspect of the disclosure, in the vehicle according to the first aspect, further includes a storing unit into which evaluation information received from the user of the vehicle relating to the location is stored, wherein the information providing unit provides the user of the vehicle with the evaluation information.

According to the vehicle according to the second aspect of the disclosure, when a user of the vehicle evaluates a place where the user of the vehicle visited, the evaluation information is stored in the storing unit. The information providing unit provides a user of the vehicle with evaluation information stored in the storing unit. The provision of evaluation information enables the user of the vehicle to select whether or not to visit the evaluated place, based on the evaluation information as a reference.

A vehicle according to a third aspect of the disclosure is, in the vehicle according to the first or second aspect, configured such that the information providing unit provides the user of the vehicle with a must-see point relating to the location.

According to the vehicle according to the third aspect of the disclosure, the information providing unit provides a user of the vehicle with a must-see point. The provision of a must-see point enables the user of the vehicle to select whether or not to visit a place having the must-see point, based on the must-see point as a reference.

A vehicle according to a fourth aspect of the disclosure is, in the vehicle according to any one of the first to third aspects, configured such that the information providing unit recommends the user of the vehicle to visit the location or provides the user of the vehicle with information relating to the location, depending on information regarding at least one of a season, weather, a year, a month, and a day of a week.

According to the vehicle according to the fourth aspect of the disclosure, guidance or information that is not appropriate depending on a season, weather, a year, a month, or a day of a week is able to be suppressed from being provided for a user of the vehicle.

A vehicle according to the disclosure has an effect in that, in a vehicle that an unspecified number of persons use, a new attraction is able to be provided to a user of the vehicle.

### BRIEF DESCRIPTION OF THE DRAWINGS

Exemplary embodiments of the disclosure will be described in detail based on the following figures, wherein:

FIG. 1 is a diagram illustrating a front side of a driver seat and a front passenger seat in a vehicle of an embodiment and illustrates a state in which a current location of the vehicle is displayed on a head-up display;

FIG. 2 is another diagram illustrating the front side of the driver seat and the front passenger seat in the vehicle of the embodiment and illustrates a state in which guidance recommending a user of the vehicle to visit a predetermined place is displayed on the head-up display;

FIG. 3 is still another diagram illustrating the front side of the driver seat and the front passenger seat in the vehicle of the embodiment and illustrates a state in which a route to the predetermined place is displayed on the head-up display;

FIG. 4 is still another diagram illustrating the front side of the driver seat and the front passenger seat in the vehicle of the embodiment and illustrates a state in which information about the predetermined place is displayed on the head-up display; and

FIG. 5 is still another diagram illustrating the front side of the driver seat and the front passenger seat in the vehicle of the present embodiment and illustrates a state in which a route to and a quiz about the predetermined place are displayed on the head-up display.

### DETAILED DESCRIPTION

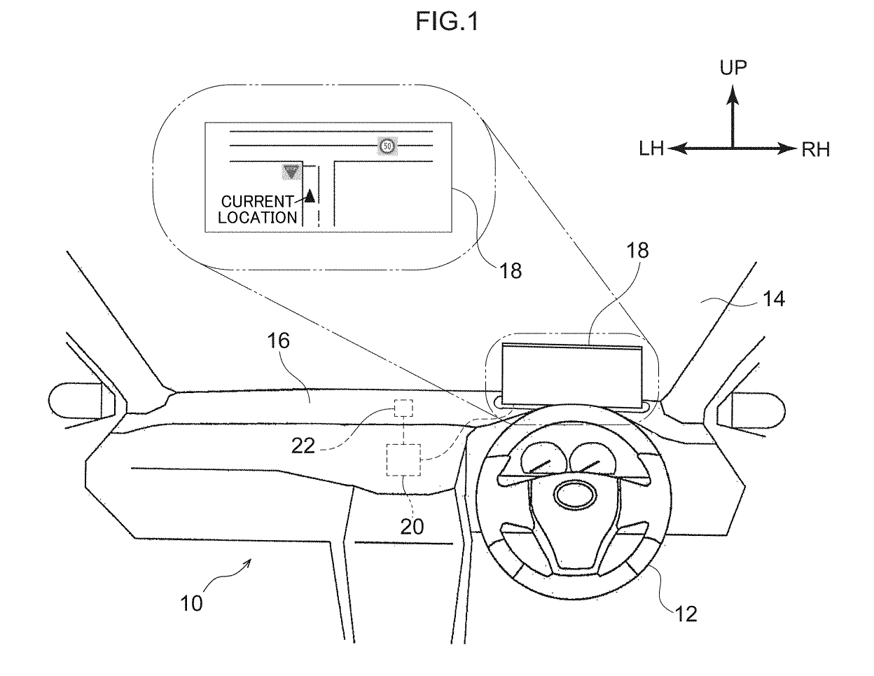

Next, a vehicle according to an embodiment of the disclosure will be described using FIGS. 1 to 5. The right-hand side, the left-hand side, and the upper side of the vehicle are indicated by an arrow RH, an arrow LH, and an arrow UP, respectively. In the following description, it is assumed that the front and rear direction, the right and left direction, and the up and down direction, in the case of being used without special note, indicate the front and rear in the vehicle longitudinal direction, the right and left in the vehicle lateral direction, and the up and down in the vehicle vertical direction, respectively.

As illustrated in FIG. 1, a vehicle 10 in the present embodiment is a vehicle that is assumed to be used by an unspecified number of persons as in the case of car sharing and the like. The vehicle 10 includes a steering wheel 12 operated by a user. The vehicle 10 also includes a head-up display 18 disposed on the front side of the steering wheel 12 and on the rear side of a front windshield glass 14 and that serves as an information providing unit placed on an instrument panel 16. The vehicle 10 still also includes a control unit 20 that makes the head-up display 18 display various types of guidance and information and the like and that serves as a counting unit and a storing unit.

The head-up display 18 is formed using a transparent plate-shaped material through which a user (driver) of the vehicle 10 is able to visually recognize a front view through the front windshield glass 14. The head-up display 18 is connected to the control unit 20, which will be described later. The connection enables various types of guidance and information, which will be described later, to be configured to be displayed on the head-up display 18.

The control unit 20 is configured including a CPU, a ROM, a RAM, and the like. In the control unit 20, data on maps and data on the locations of and information about respective facilities (facilities such as scenic sites, restaurants, parks, or convenience stores) are stored in advance. Data in the control unit 20 may be configured to be updated periodically by wired or wireless communication.

To the control unit 20, a location unit 22 that is configured with a GPS receiver, a gyro sensor, or the like and that serves as a location acquiring unit is connected. Based on a signal from the location unit 22 and map data in the control unit 20, a location (present location) of the vehicle 10 is configured to be displayed on the head-up display 18.

The control unit 20 counts the number of visits to a location (place) acquired by the location unit 22. For example, the control unit 20 counts the number of visits to a specific scenic site, restaurant, park, convenience store, or the like.

When the control unit 20 determines that a user of the vehicle 10 visited a specific scenic site, restaurant, park, convenience store, or the like, the control unit 20 makes the head-up display 18 display a message requesting the user of the vehicle 10 to input evaluation information about the place or makes a not-illustrated speaker output a voice requesting the user to input evaluation information about the place. As a trigger to determine that a user of the vehicle 10 visited a specific scenic site, restaurant, park, convenience store, or the like, stoppage time or the like of the vehicle may be used.

### Operation and Effect of Embodiment

Next, an operation and an effect of the embodiment will be described.

As illustrated in FIG. 1, according to the vehicle 10 of the embodiment, the number of visits to a location (place) acquired by the location unit 22 is counted by the control unit 20. In the case of the vehicle 10 of the embodiment, which an unspecified number of persons use as in the case of car sharing, various persons (users) visit various places and the numbers of visits to such places are counted by the control unit 20.

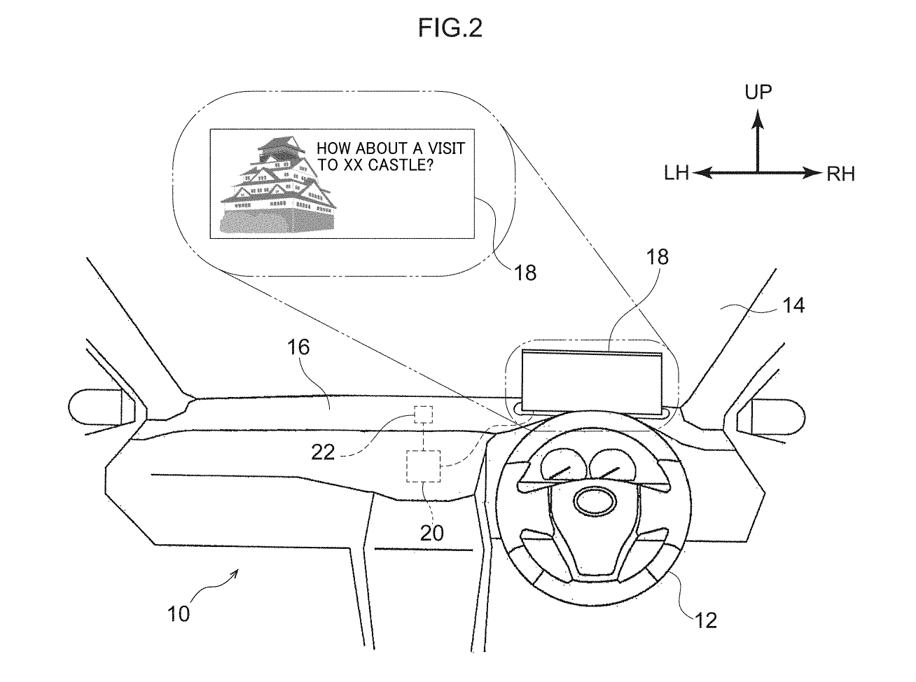

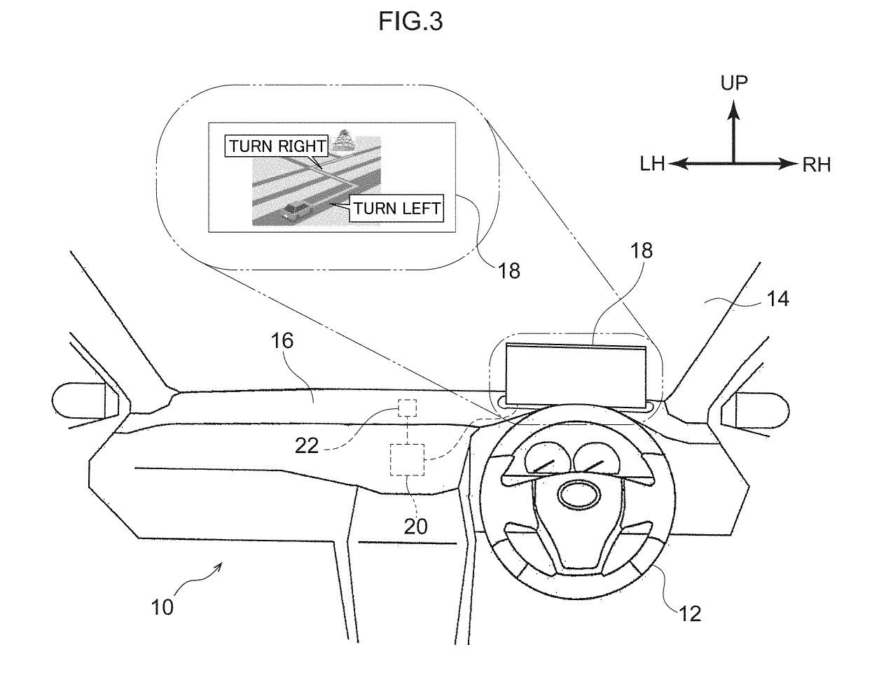

In a case that the number of visits counted by the control unit 20 exceeds a predetermined number and when the ignition of the vehicle 10 is switched on (when the vehicle 10 is brought to a drivable state again), the control unit 20 makes the head-up display 18 display guidance recommending a user of the vehicle 10 to visit a place where the counted number of visits thereto exceeds the predetermined number, as illustrated in FIG. 2. When the user selects to visit the place by a voice or operating an operation unit, the control unit 20 makes the head-up display 18 display a route to the place, as illustrated in FIG. 3.

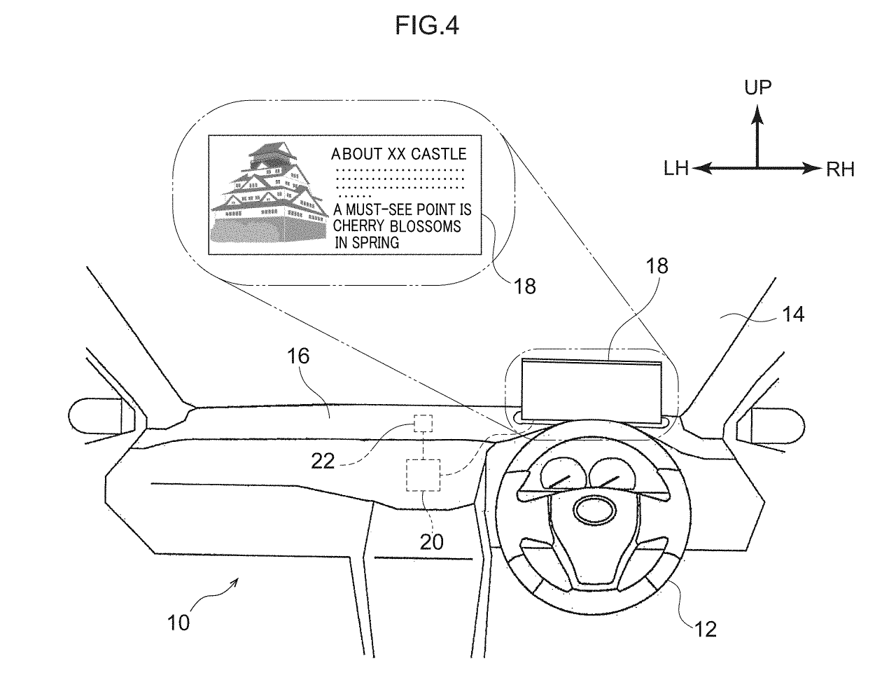

In a case that the number of visits counted by the control unit 20 exceeds a predetermined number and when the ignition of the vehicle 10 is switched on (when the vehicle 10 is brought to a drivable state again), the control unit 20 may also make the head-up display 18 display information about a place where the counted number of visits thereto exceeds the predetermined number, as illustrated in FIG. 4. On this occasion, a “must-see point” that is stored in the control unit 20 in advance is also displayed on the head-up display 18. Although examples of such a “must-see point” include plants such as a cherry tree, specific places such as a cape, and animals bred in a zoo or an aquarium, other types of “must-see points” may be displayed. When the user selects to visit the place by a voice or operating the operation unit, the control unit 20 makes the head-up display 18 display a route to the place, as illustrated in FIG. 3.

In the embodiment, in some cases, the control unit 20 does not recommend a user of the vehicle 10 to visit a place where the number of visits thereto exceeds a predetermined number or does not provide the user of the vehicle 10 with information about the place depending on a season, weather, a year, a month, or a day of a week. For example, in a case that the place is not open in a specific season, weather, year, month, or day of a week, and the like, the control unit 20 does not recommend the user of the vehicle 10 to visit the place or does not provide the user of the vehicle 10 with information about the place. This configuration enables guidance or information that is not appropriate depending on a season, weather, a year, a month, or a day of a week to be suppressed from being provided to a user of the vehicle 10.

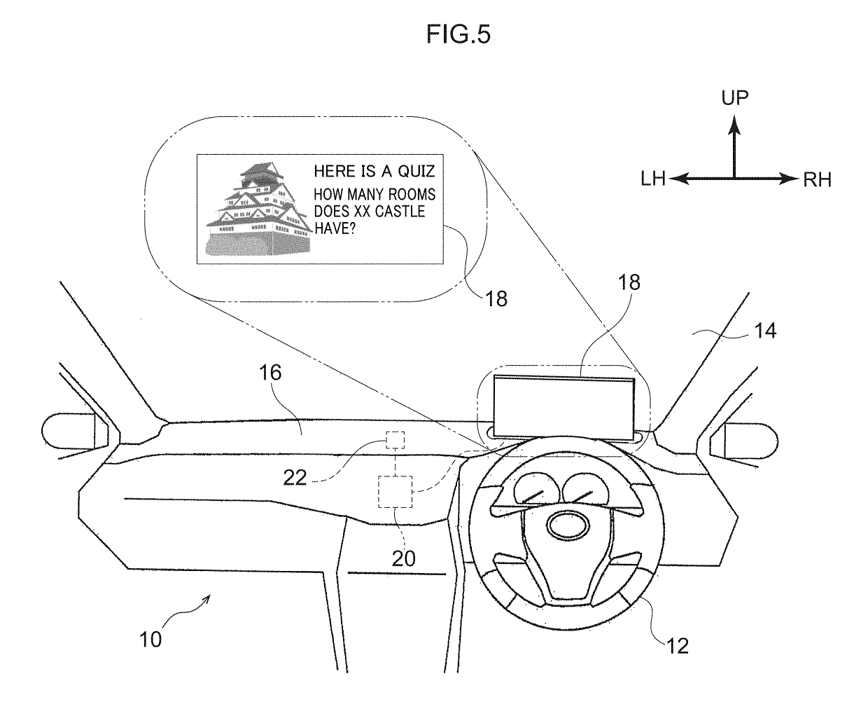

When a user selects to visit such a place described above by a voice or operating the operation unit, the user is quizzed about the place as illustrated in FIG. 5 in addition to being provided with guidance to the place illustrated in FIG. 3. The user of the vehicle 10 may reply an answer to the quiz by a voice or operating the operation unit or may directly confirm the answer when the user visits the place.

As described thus far, the embodiment is able to provide users of the vehicle 10, which an unspecified number of persons use, with a new attraction.

Although, in the embodiment, an example in which various types of guidance and information described above were displayed on the head-up display 18 was described, the disclosure is not limited to the example. For example, various types of guidance and information described above may be displayed on a monitor that serves as an information providing unit in a navigation device. Various types of guidance and information described above may also be provided by a voice through a speaker that serves as an information providing unit.

The disclosure was described above through an embodiment thereof, but the disclosure is not limited to the above embodiment, and it is needless to say that various modifications other than those described above may be made and implemented without departing from the subject matter of the disclosure.

What is claimed is:

1. A vehicle comprising:
a location acquiring unit that acquires a location of a vehicle;
a counting unit that counts a number of visits to a location acquired by the location acquiring unit; and
an information providing unit that, in a case that the number of visits counted by the counting unit exceeds a predetermined number, recommends a user of the vehicle to visit the location or provides the user of the vehicle with information about the location.

2. The vehicle according to claim 1 further comprising a storing unit into which evaluation information received from the user of the vehicle relating to the location is stored, wherein the information providing unit provides the user of the vehicle with the evaluation information.

3. The vehicle according to claim 1, Wherein the information providing unit provides the user of the vehicle with a must-see point relating to the location.

4. The vehicle according to claim 1, wherein the information providing unit recommends the user of the vehicle to visit the location or provides the user of the vehicle with information relating to the location, depending on information regarding at least one of a season, weather, a year, a month, and a day of a week.
